(19) United States
(12) Patent Application Publication
(10) Pub. No.: US 2009/0068517 A1
(43) Pub. Date: Mar. 12, 2009

(54) SYSTEMS AND METHODS FOR VERIFYING FUEL CELL FEED LINE FUNCTIONALITY

(75) Inventors: Claus Aabjerg Andersen, Kolding (DK); Thomas Enne Hjort, Vejle (DK)

Correspondence Address: LOWRIE, LANDO & ANASTASI, LLP, ONE MAIN STREET, SUITE 1100, CAMBRIDGE, MA, 02142, US

(73) Assignee: AMERICAN POWER CONVERSION CORPORATION, West Kingston, RI (US)

(21) Appl. No.: 11/852,653

(22) Filed: Sep. 10, 2007

(51) Int. Cl. H01M 8/24; H01M 8/02

(52) U.S. Cl. 429/25

(57) ABSTRACT

Systems and methods for verifying fuel cell system functionality are provided. Various tests and/or exercises may be executed while the fuel cell system is in standby mode to detect potential sources of malfunction. In some examples, one or more tests may be designed to detect leaks or ruptures in various reactant supply lines and/or to test the functionality of various valves associated therewith. A controller may be provided to automatically perform the disclosed tests. In certain examples, the disclosed tests may be conducted without the need to provide each component of a fuel cell system with individual electrical feedback.

### CROSS-REFERENCE TO RELATED APPLICATION

This application relates to U.S. patent application Ser. No. ______ entitled SYSTEMS AND METHODS FOR VERIFYING FUEL CELL FEED LINE FUNCTIONALITY (Attorney Docket No. A2000-706319), by Andersen et al., filed on even date herewith, which is hereby incorporated herein by reference in its entirety for all purposes.

### FIELD OF THE INVENTION

At least one embodiment of the present invention relates generally to fuel cells and, more particularly, to systems and methods for verifying fuel cell feed line functionality.

### BACKGROUND OF THE INVENTION

Fuel cells have emerged as a viable source of power for use in various applications. Fuel cells are generally considered favorable based on factors including their dependability, high associated energy density, scalability, environmental cleanliness, quietness, minimal maintenance requirements and ability to accommodate extended runtime demands. As an alternative to conventional batteries and generators, fuel cells are increasingly being implemented in standby or backup power supplies.

High availability requirements may place heavy reliance upon backup power generation, such as in information technology systems involving complex data centers and/or network architectures in which downtime can cause equipment damage, breach of data security and loss of productivity. Safety concerns may present an additional motivation for ensuring operability, particularly in the context of fuel cell powered backup supplies. Despite the constant threat of power failures, deployed backup power devices tend to be in standby mode most of the time making detection of potential sources of malfunction a challenge.

### BRIEF SUMMARY OF THE INVENTION

In accordance with one or more embodiments, the invention relates generally to systems and methods for verifying fuel cell feed line functionality.

In accordance with one or more embodiments, the invention relates to a back-up power supply system. The system may comprise a fuel cell stack, a feed line fluidly connecting the fuel cell stack to a fuel supply, a pressure sensor disposed along the feed line, configured to detect a pressure within the feed line, and a first valve configured to regulate flow of fuel to the fuel cell stack. The system may further comprise a controller, in communication with the pressure sensor and the first valve, configured to generate a first control signal to actuate the first valve to supply fuel to the fuel cell stack during a first mode of operation to provide output power from the fuel cell stack, and to generate a second control signal to close the valve during a second mode of operation. The controller may be further configured to induce a feed line condition during the second mode of operation to verify feed line functionality.

The system may further comprise an excess flow valve disposed along the feed line, wherein the feed line condition comprises actuation of the excess flow valve. The system may still further comprise a purge valve disposed downstream of the excess flow valve. The controller may be configured in the second mode of operation to generate a first control signal to open the purge valve, generate a second control signal to accelerate a flow of fuel at the first valve, detect a first pressure along the feed line with the pressure sensor, and compare the first detected pressure to a threshold value. The controller may be further configured to generate a warning in response to the first detected pressure exceeding the threshold value. The controller may be configured to generate the second control signal a first predetermined time interval after generation of the first control signal. The controller may be further configured to detect the first pressure along the feed line after a second predetermined time interval.

The controller may be further configured to induce a reset of the excess flow valve during the second mode of operation. The controller may be configured to generate a third control signal to close the first valve, generate a fourth control signal to close the purge valve, generate a fifth control signal to open the first valve, detect a second pressure along the feed line with the pressure sensor, and compare the second detected pressure to the first detected pressure. The controller may be further configured to generate a warning if the second detected pressure is less than the first detected pressure. The controller may be configured to generate the fifth control signal after a third predetermined time interval.

The feed line condition may comprise a pressure drop above a threshold value. The system may further comprise a purge valve disposed along the feed line. The controller may be configured in the second mode of operation to generate a first control signal to close the first valve, detect a first pressure along the feed line with the pressure sensor, generate a second control signal to open the purge valve, detect a second pressure along the feed line with the pressure sensor, and evaluate a pressure drop based on the first and second detected pressures. The controller may be further configured to generate a warning if the pressure drop is less than the threshold value.

The feed line condition may comprise a feed line pressure increase. The system may further comprise a purge valve disposed along the feed line. The controller may be configured in the second mode of operation to generate a first control signal to close the first valve, generate a second control signal to open the purge valve, generate a third control signal to close the purge valve after a predetermined time interval, detect a first pressure along the feed line with the pressure sensor, generate a first control signal to open the first valve, detect a second pressure along the feed line with the pressure sensor, and compare the first detected pressure to the second detected pressure. The controller may be further configured to generate a warning if the second detected pressure is less than the first detected pressure.

In accordance with one or more embodiments, the invention relates to a method of operating an uninterruptible power supply. The method may comprise providing power derived from a fuel cell stack to a load during a first mode of operation, powering-down the fuel cell stack during a second mode of operation, and inducing a feed line condition during the second mode of operation to verify feed line functionality. Inducing a feed line condition during the second mode of operation to verify feed line functionality may comprise inducing actuation of an excess flow valve. Inducing actuation of an excess flow valve may comprise opening a purge valve, and accelerating a flow of fuel at a first valve disposed along the feed line. The method may further comprise detecting a first pressure along the feed line, and comparing the first detected pressure to a threshold value. The method may still further comprise generating a warning in response to the first detected pressure exceeding the threshold value. The method may further comprise inducing a reset of the excess flow valve.

Inducing a feed line condition during the second mode of operation to verify feed line functionality may comprise inducing a feed line pressure drop above a threshold value. Inducing a pressure drop above a threshold value may comprise closing a first valve disposed along the feed line, detecting a first pressure along the feed line, opening a purge valve, detecting a second pressure along the feed line, and evaluating a pressure drop based on the first and second detected pressures. The method may further comprise generating a warning if the pressure drop is less than the threshold value.

Inducing a feed line condition during the second mode of operation to verify feed line functionality may comprise inducing a feed line pressure increase. Inducing a feed line pressure increase may comprise closing a first valve disposed along the feed line, opening a purge valve, closing the purge valve after a predetermined time interval, detecting a first pressure along the feed line, opening the first valve, detecting a second pressure along the feed line, and comparing the first detected pressure to the second detected pressure. The method may further comprise generating a warning if the second detected pressure is less than the first detected pressure.

In accordance with one or more embodiments, the invention relates to an uninterruptible power supply. The power supply may comprise a power input configured to receive input power during a first mode of operation, and a power output configured to provide output power to a load. The power supply may further comprise a controller operatively coupled to the power input and the power output, configured to provide output power at the power output derived from input power received at the power input during the first mode of operation, provide output power at the power output derived from a fuel cell stack during a second mode of operation, and induce a fuel cell stack feed line condition during the first mode of operation to verify feed line functionality. The controller may be configured to induce actuation of an excess flow valve associated with the fuel cell stack feed line. The controller may be configured to induce a reset of the excess flow valve. The controller may be configured to induce a pressure drop in the fuel cell stack feed line above a threshold value. The controller may be configured to induce a pressure increase in the fuel cell stack feed line.

Other advantages, novel features and objects of the invention will become apparent from the following detailed description of the invention when considered in conjunction with the accompanying drawings.

### BRIEF DESCRIPTION OF THE DRAWINGS

The accompanying drawings are not intended to be drawn to scale. In the drawings, each identical or nearly identical component that is illustrated in various figures is represented by like numeral. For purposes of clarity, not every component may be labeled in every drawing. Preferred, non-limiting embodiments of the present invention will be described with reference to the accompanying drawings, in which:

FIG. 1 illustrates a fuel cell system in accordance with one or more embodiments of the present invention;

FIG. 2a illustrates multiple fuel cell modules contained in a system rack in accordance with one or more embodiments of the present invention;

FIG. 2b illustrates components of a reactant feed line of a fuel cell system in accordance with one or more embodiments of the present invention;

FIG. 3 presents a flow chart illustrating a fuel cell feed line test sequence to verify proper position of manual valves and/or performance of a hydrogen supply valve in accordance with one or more embodiments of the present invention;

FIG. 4 presents a flow chart illustrating a fuel cell feed line test sequence to verify proper position of manual valves thereof in accordance with one or more embodiments of the present invention;

FIG. 5 presents a flow chart illustrating a fuel cell feed line test sequence to confirm functionality of an excess flow valve thereof in accordance with one or more embodiments of the present invention;

FIG. 6 presents a flow chart illustrating a subroutine of the test sequence of FIG. 5 to confirm resetting of the excess flow valve in accordance with one or more embodiments of the present invention;

FIG. 7 presents a flow chart illustrating a fuel cell feed line leakage test sequence in accordance with one or more embodiments of the present invention; and

FIG. 8 presents an example of a leak score rubric for use with a feed line leakage test in accordance with one or more embodiments of the present invention.

### DETAILED DESCRIPTION OF THE INVENTION

This invention is not limited in its application to the details of construction and the arrangement of components as set forth in the following description or illustrated in the drawings. The invention is capable of embodiments and of being practiced or carried out in various ways beyond those exemplarily presented herein.

In accordance with one or more embodiments, the present invention relates generally to the prevention of fuel cell malfunction and to the detection of potential problems prior to bringing fuel cells online. Beneficially, functionality may be confirmed even when fuel cells are subjected to lengthy standby periods. Systems and methods disclosed herein may be effective in verifying fuel cell system operability to avoid downtime of equipment supported by the fuel cells, and may also serve to increase confidence in the overall safety of fuel cell powered backup supplies. The disclosed systems and methods may aid in identifying specific points of failure to facilitate maintenance.

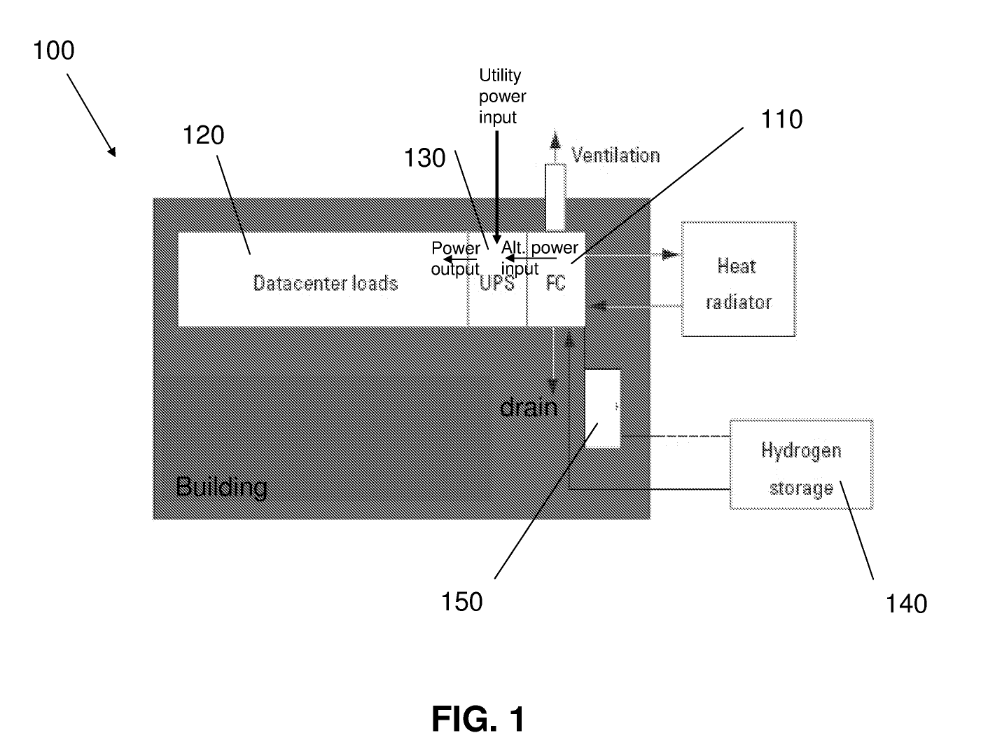

In accordance with one or more embodiments, the present invention may relate to systems including one or more fuel cells. A fuel cell may include an anode wherein oxidation reactions occur, and a cathode wherein reduction reactions occur, generally converting chemical energy from a fuel and an oxidant to generate electricity. As illustrated in FIG. 1, a fuel cell installation should generally include a water drain and hot air exhaust for removal of reaction byproducts. A heat radiator may also be provided to cool the fuel cells during operation.

The fuel is typically hydrogen, but may also involve other suitable chemistries, for example, alcohols and hydrocarbons such as methane. The oxidant is generally an oxidizing agent, such as oxygen, carbon dioxide or air. Any type of fuel cell commonly known to those of skill in the art may be utilized. For example, the fuel cells may be proton exchange membrane fuel cells such as direct methanol fuel cells, solid oxide fuel cells, molten carbonate fuel cells, alkaline fuel cells such as metal hydride fuel cells, and/or phosphoric acid fuel cells.

In accordance with one or more embodiments, fuel cells 110 of a system 100 may be in electrical communication with one or more electrical loads 120, as illustrated in FIG. 1. Fuel cells 110 may generally deliver power to the load 120 via an electrical circuit. In some embodiments, the load 120 may relate to operation of a vehicle, portable or small equipment, or a stationary application in a home or commercial environment. In at least one embodiment, the electrical load 120 may be generally affiliated with a network-critical physical infrastructure (NCPI). For example, the fuel cells 120 may be coupled to an infrastructure system involving network architectures and data centers to support associated demands such as electrical, security, management and/or cooling requirements.

The fuel cells disclosed herein may be used in continuous operation or intermittently, for example, to generate power on demand. In accordance with one or more embodiments, the fuel cells may function as a primary power source. Alternatively, the fuel cells may function as a backup power source, such as to provide power during any period when a normal power supply is incapable of performing acceptably. When operating as a backup power source, the fuel cells may be in standby mode until they are brought online. The fuel cells may therefore be offline or in standby mode for a majority of the time when used as a backup power source.

In accordance with one or more embodiments, the disclosed fuel cells may be used in an uninterruptible power supply (UPS) 130 as illustrated in FIG. 1. In different embodiments, one of a number of UPS's commercially available from American Power Conversion Corp. of West Kingston, R.I. may be used. Furthermore, one or more UPS's described in U.S. Pat. No. 5,982,652 to Simonelli et al., hereby incorporated herein by reference in its entirety for all purposes, may be used in one or more embodiments of the invention. The UPS 130 may generally include an input to receive input power from a primary power source, such as utility or other facility power, and an output to deliver power to the load 120. The UPS 130 may include one or more features for conditioning power supplied to the load 120. The UPS 130 may also include an input for receiving power from an alternate power source, such as the fuel cell 110. The fuel cell 110 may be included within the UPS 130. In some embodiments, the fuel cells 110 may produce DC power with electrical characteristics similar to batteries.

In at least one embodiment, fuel cells may be employed in combination with stored energy devices (e.g., super capacitors and batteries) together in a UPS system as various sources of alternate power. Such a configuration may result in two or more alternate power sources supplying power to an input of a UPS. Without wishing to be bound by any particular theory, fuel cells may require a period of time to come up to power, such as several seconds, so a separate power source may aid in bridging a power gap at initial moments of an outage. In some embodiments, a converter, such as a DC/DC converter, may be included to step-up or boost a voltage output of the fuel cell 110 so that the power can be routed through the UPS 130.

In accordance with one or more embodiments, a disclosed fuel cell system may be generally scalable to provide a desired voltage output. For example, multiple fuel cells may be electrically coupled in various configurations, such as in series, parallel or other circuit arrangement to form a fuel cell stack capable of outputting a desired voltage. In some embodiments, two or more fuel cells may be mounted in a fuel cell stack. In other embodiments, a fuel cell stack may include three or more coupled fuel cells. Likewise, multiple fuel cell stacks may be electrically coupled within the disclosed fuel cell systems for additional scalability.

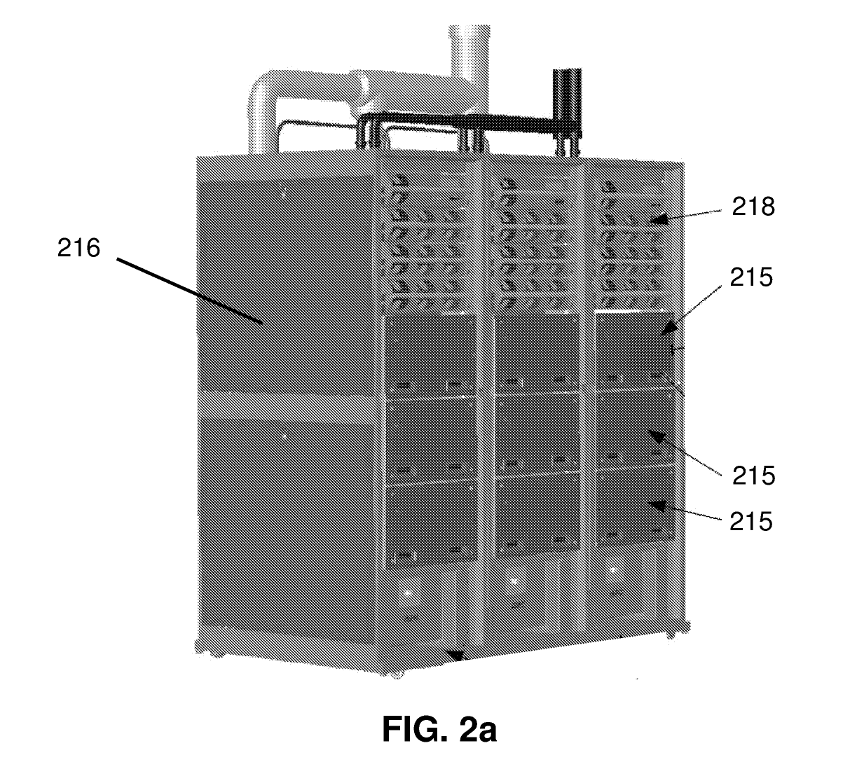

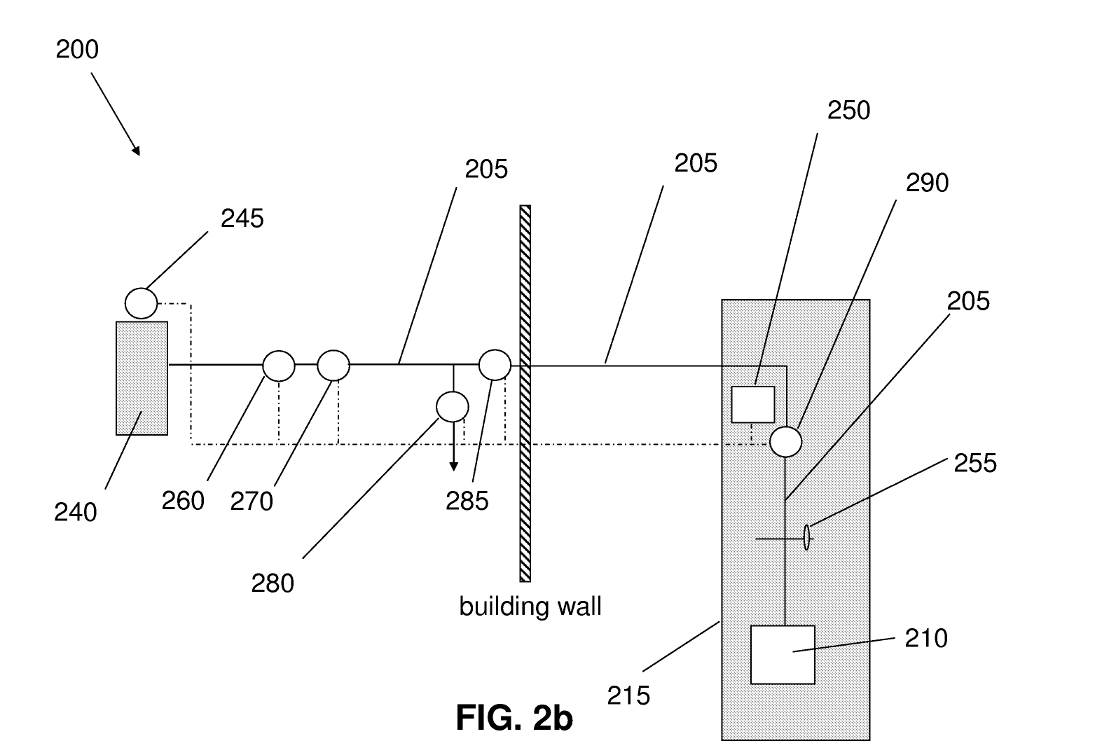

In accordance with certain embodiments of the present invention, one or more fuel cell stacks may be included in a fuel cell module. Fuel cell modules may generally be compact and modular to facilitate scalability and/or maintenance. In some embodiments, fuel cell modules may be rack-mountable or otherwise compatible with existing power cabinetry to assist coupling. As illustrated in FIG. 2afor example, multiple fuel cell modules 215 may be mounted in a rack 216. In some embodiments, the fuel cell modules 215 may be coupled in a parallel configuration within the rack 216. The fuel cell modules 215 may be in electrical communication with one or more converters 218 within the rack 216 to regulate output power. In some embodiments, a disclosed system may include one or more fuel cell modules such as HYPM® XR Hydrogen Fuel Cell Power Modules, commercially available from Hydrogenics Corporation of Ontario, Canada.

A fuel cell module may generally include one or more features directed to establishing fluid connections between fuel cells thereof and various reactant feed lines. In some embodiments, one or more manifolds may aid in establishing the fluid connections therebetween. A fuel cell module may also include one or more valves associated with various reactant feed lines. In at least one embodiment, a fuel cell module may also include a fuel cell management system, such as a controller, generally configured to carry out control, monitoring and/or safety functions associated with fuel cell operation. For example, the module controller may control hydrogen and air flow to the fuel cell stacks and may regulate current from the fuel cell module. In some embodiments, one or more of the valves may be responsive to the controller. A fuel cell module may also include one or more sensors to monitor an operational parameter of the system. For example, a pressure sensor may be positioned along a fuel feed line. In some embodiments, one or more sensors may be in communication with the controller to facilitate monitoring and regulating operational parameters of a fuel cell system.

The fuel cells may generate power so long as sufficient fuel and oxidant is supplied. As illustrated in FIG. 1, while the fuel cells 110 may be installed indoors in proximity to an electrical load, the fuel source 140 and oxidant supply may be stored outside of the physical building for safety. The fuel and oxidant may be supplied to the fuel cells through a system of reactant feed lines as the reactants are consumed. The fuel source 140 may involve fuel contained in, for example, standard shipping bottles. Extended runtimes may be enabled by providing a larger supply of reactants. In at least one embodiment, one or more fuel cell stacks or modules may be fluidly connected to a fuel storage system.

In accordance with one or more embodiments, various devices may be used to control the amount of reactant supplied to the fuel cells 110, such as the amount of fuel supplied from the fuel source 140. For example, pumps, flow regulators or valves such as needle valves, ball valves, angle-seat valves, butterfly valves, check valves, elliptic valves, metering valves, pinch valves, proportioning valves, solenoid valves pressure and/or temperature compensated variable flow valves may be implemented. The valves may be manual or automatic and may be positioned at various locations throughout the system. Some valves may be associated with the fuel source 140. Other valves may be positioned along a reactant feed line, such as a fuel supply line, either outside of the building or within the building. Still other valves may be located within a fuel cell stack. In at least some embodiments, as discussed above, some valves may be positioned within a fuel cell module.

In accordance with one or more embodiments, a controller 150 may be present to carry out control, monitoring and safety functions associated with fuel cell system operation. In some embodiments, one or more system valves may be responsive to the controller 150. One or more system sensors, such as a pressure sensor along a fuel feed line, may be in communication with the controller to provide system feedback. In at least one embodiment, the controller, valves and/or sensors may be used to verify fuel cell system functionality as discussed in greater detail below. As discussed above, the controller 150 and/or sensors may be positioned within a fuel cell module. Alternatively, the controller 150 and/or sensors may be positioned remotely relative to the fuel cells. For example, one or more fuel cell modules may be in communication with a fuel cell system controller. In some embodiments, the controller 150 may be incorporated within the UPS 130. In at least one embodiment, a fuel cell system controller may bridge communication between one or more fuel cell module controllers and a UPS controller. The fuel cell system controller may generally perform system surveillance as discussed herein.

FIG. 2b illustrates various valves and sensors that may be associated with a reactant feed line, such as hydrogen supply line 205 of a fuel cell system 200 in accordance with one or more embodiments of the present invention. The hydrogen supply line 205 generally provides a fluid connection between the hydrogen source 240 and one or more fuel cells 210 of a fuel cell module 215. In the illustrated embodiment, the controller 250 is positioned within the fuel cell module 215. A sensor 255 may be configured to detect an operational parameter of the hydrogen supply line 205, such as pressure, and may be in communication with the controller 250. A bottle valve 245 positioned at the hydrogen source 240 may be a manual valve to facilitate replacement of the hydrogen source 240. An excess flow valve 260, for example a SWAGELOK® overflow valve, may be generally configured to terminate flow of hydrogen along the hydrogen supply line 205 in response to a change in flow rate, such as may be due to a pipe rupture. A hydrogen supply valve 270 may serve as a safety valve, such as an emergency power off (EPO) valve. A building inlet valve 285 may be a manual valve and may be used for safety to shut down hydrogen supply in the event of an emergency. A safety shutoff valve 290, such as a manual ball valve, positioned within the fuel cell module 215 may provide the system 200 with additional safety characteristics by facilitating manual shutoff of the hydrogen supply. In some embodiments, the valve 290 may be a double solenoid valve. A purge valve 280 may be included to facilitate various tests of fuel cell system functionality as discussed in greater detail below. Any of the valves, such as valves 260, 270, 280 and 290 may be in communication with the controller 250. Additional fuel cells and/or fuel cell modules, valves and/or sensors may be included beyond those exemplarily presented and discussed herein. Likewise, not all of the components illustrated in FIG. 2b need be present.

Proper fuel cell operability may be essential to meet high availability requirements and to ensure the safety of systems involving fuel cell powered devices. The relatively low activity of the fuel cells at run time level, particularly in embodiments wherein the fuel cells are used for backup power supplies, may contribute to fuel cell malfunction. Human error and/or general equipment breakdown may also lead to problems with fuel cell operability. Leaks or ruptures in reactant supply lines are one potential source of failure. Unintentionally closed manual valves associated with reactant sources or feed lines, such as may occur during replacement of fuel supplies, may leave the system without needed reactants. Malfunction of automatic valves, for example causing them to remain in the wrong position or otherwise unable to actuate properly, present additional potential failures.

One or more embodiments of the present invention may generally relate to tests or exercises for verifying fuel cell system functionality. The disclosed tests may be generally effective in preventing fuel cell malfunction, detecting potential problems prior to bringing fuel cells online, and in identifying specific points of failure to facilitate maintenance. The tests may be performed manually or, alternatively, may be performed by a system controller. In at least one embodiment, the verification exercises may be conducted while the fuel cells are offline in standby mode.

A fuel cell system may operate in various modes of operation. For example, the fuel cell system may be online delivering power to an electrical load in a first mode of operation, and the fuel cell system may also operate in a second mode of operation during which the fuel cell system is offline. In some embodiments, the controller may perform tests on system operability as disclosed herein during the offline mode of operation. In at least one embodiment, a fuel cell system may alternate between operating in the first mode of operation and operating in the second mode of operation. For example, the fuel cell system may operate in the first mode of operation during power failures, and may otherwise operate in the second mode of operation during fuel cell system standby.

In accordance with one or more embodiments, various tests or exercises may be performed during a second or standby mode of operation, such as by a controller. Tests to be performed may generally be selected and/or designed to evaluate potential areas of concern within a fuel cell system. For example, during the second mode of operation tests may be conducted to exercise fuel cells, such as to prevent them from drying out. Tests relating to operability of fuel cell cooling and/or communication systems may also be conducted. Still other exercises, such as those discussed in greater detail below, may generally relate to verifying functionality of fuel cell feed lines.

In accordance with one or more embodiments, one or more tests may be designed to detect leaks or ruptures in various reactant supply lines and/or to test the functionality of various valves associated therewith. In some embodiments, tests may monitor one or more operational parameters of a feed line. For example, feed line pressure may be monitored over time. In other embodiments, tests may manipulate system components and/or strategically direct flow streams to verify proper position and/or operation of one or more system valves. In some embodiments, one or more tests may generally be designed to induce an expected system condition. For example, a test may strategically maneuver one or more feed line components to compare a resulting feed line condition to an expected feed line condition. A test may also simulate a foreseeable event to assess system response. For example, in some embodiments a test may simulate an event, such as a feed line rupture, to induce an expected system condition. A feed line condition may generally relate to an operational parameter of the feed line, such as feed line pressure or pressure drop. A feed line condition may also refer to the position of one or more valves associated with the feed line.

In some embodiments, the controller may be configured to perform a group or package of fuel cell system functionality tests. Each test may generally involve a protocol, such as a sequence of test steps. In some embodiments, a series of tests may be repeated continuously during a second mode of operation. In other embodiments, individual tests may be performed continuously. Alternatively, various tests may be performed intermittently. In at least one embodiment, various fuel cell system tests may be conducted regularly, such as at predetermined time intervals.

In accordance with one or more embodiments, the controller may provide a user or operator of the disclosed systems with feedback based on the results of various executed tests. For example, in some embodiments the controller may keep a log of test results. In at least one embodiment, the controller may provide a user with visual and/or audible cues based on test results. The user may evaluate test results and/or collected data to take any preventative and/or corrective action as believed necessary. For example, the user may further inspect a potential source of malfunction, schedule maintenance or continue to monitor future test results. In potentially dangerous situations, the user may decide to take immediate action, such as by terminating the supply of one or more reactants to a fuel cell. In various embodiments, a user of the disclosed fuel cell systems may adjust the sensitivity of the system with regard to various conducted tests. For example, pass criterion and/or ranges of tolerance for various tests may be predetermined. In some embodiments, the user may specify what type of feedback the controller should provide and what action, if any, the system should automatically take in response to certain tests results. For example, the controller may be configured to shut-off hydrogen supply in the event of one or more tests detecting a dangerous system condition.

The controller, such as the controller 250 may be, for example, a mechanical controller, a pneumatic controller, a computer, a semiconductor chip, or the like. Furthermore, the controller may be incorporated in a UPS and also function as the main controller of the UPS. Fuel cells may also be incorporated in the UPS. The controller may be incorporated into a feedback or a feedforward control loop. In some embodiments, the controller may comprise an algorithm that can execute one or more system tests and/or exercises to monitor fuel cell system functionality. The algorithm can include routines, techniques and sub-algorithms. The controller may be a “hard-wired” system, or the controller may be programmable and adaptable as needed.

The controller may be implemented using one or more computer systems, for example, a general-purpose computer such as those based on an Intel PENTIUM®-type processor, a Motorola PowerPC® processor, a Sun UltraSPARC® processor, a Hewlett-Packard PA-RISC® processor, or any other type of processor or combinations thereof. Alternatively, the computer system may include specially-programmed, special-purpose hardware, for example, an application-specific integrated circuit (ASIC) or controllers intended for fuel cell systems. In at least one embodiment, the controller may include a digital signal processor (DSP) such as one commercially available from Texas Instruments®. In other embodiments, the controller may be based on field programmable gate arrays (FPGA) technology or other embedded technology.

The computer system can include one or more processors typically connected to one or more memory devices, which can comprise, for example, any one or more of a disk drive memory, a flash memory device, a RAM memory device, or other device for storing data. The memory is typically used for storing programs and data during operation of the disclosed fuel cell systems. For example, the memory may be used for storing historical data relating to operational parameters over a period of time, as well as operating data. Software, including programming code that implements embodiments of the invention, can be stored on a computer readable and/or writeable nonvolatile recording medium, and then typically copied into the memory wherein it can then be executed by the processor. Such programming code may be written in any of a plurality of programming languages, for example, Java, Visual Basic, C, C#, or C++, Fortran, Pascal, Eiffel, Basic, COBAL, or any of a variety of combinations thereof.

Components of the computer system may be coupled by one or more interconnection mechanisms, which may include one or more busses (e.g., between components that are integrated within a same device) and/or a network (e.g., between components that reside on separate discrete devices). The interconnection mechanism typically enables communications (e.g., data, instructions) to be exchanged between components of the computer system.

The computer system can also include one or more input devices, for example, a keyboard, mouse, trackball, microphone, touch screen, and other man-machine interface devices as well as one or more output devices, for example, a printing device, display screen, or speaker. In addition, the computer system may contain one or more interfaces that can connect the computer system to a communication network (in addition or as an alternative to the network that may be formed by one or more of the components of the computer system).

According to one or more embodiments of the invention, the one or more input devices may include sensors for measuring operational parameters of the fuel cell system and/or components thereof. Alternatively, the sensors, the valves and/or other system components may be connected to a communication network that is operatively coupled to the computer system. Any one or more of the above may be coupled to another computer system or component to communicate with the computer system over one or more communication networks. Such a configuration permits any sensor or signal-generating device to be located at a significant distance from the computer system and/or allow any sensor to be located at a significant distance from any subsystem and/or the controller, while still providing data therebetween. Such communication mechanisms may be effected by utilizing any suitable technique including, but not limited to, those utilizing wireless protocols.

The controller can include one or more computer storage media such as readable and/or writeable nonvolatile recording medium in which signals can be stored that define a program to be executed by one or more processors. The medium may, for example, be a disk or flash memory. In typical operation, the processor can cause data, such as code that implements one or more embodiments of the invention, to be read from the storage medium into a memory that allows for faster access to the information by the one or more processors than does the medium. The memory is typically a volatile, random access memory such as a dynamic random access memory (DRAM) or static memory (SRAM) or other suitable devices that facilitates information transfer to and from the processor.

It should be appreciated that the invention is not limited to being implemented in software, or on the computer system as exemplarily discussed herein. Indeed, rather than implemented on, for example, a general purpose computer system, the controller, or components or subsections thereof, may alternatively be implemented as a dedicated system or as a dedicated programmable logic controller (PLC) or in a distributed control system. Further, it should be appreciated that one or more features or aspects of the invention may be implemented in software, hardware or firmware, or any combination thereof. For example, one or more segments of an algorithm executable by the controller can be performed in separate computers, which in turn, can be in communication through one or more networks.

Beneficially, the disclosed tests may be conducted without the need to equip each component of the fuel cell system with individual electrical feedback. Instead, existing equipment may be used to conduct the disclosed tests. In some embodiments, existing fuel cell systems and/or UPS's may be retrofitted in accordance with one or more embodiments of the present invention. For example, a controller in accordance with one or more embodiments of the present invention, or firmware associated therewith, may be incorporated into existing systems to facilitate execution of the disclosed tests and/or exercises to verify fuel cell system functionality.

Examples of several fuel cell tests and/or exercises that may be implemented in accordance with embodiments of the present invention will now be described. Other potential tests and methods of carrying them out, though not discussed herein, will be recognized by the person of ordinary skill in the art, given the benefit of this disclosure, to further verify fuel cell functionality and to evaluate particular areas of concern within fuel cell systems.

In accordance with one or more embodiments, one or more tests may be performed to verify the position and/or operability of various valves associated with the reactant supply line 205. In some embodiments, these tests may manipulate system components, such as valves and flow streams, through a sequence of strategic configurations to induce an expected system condition. A resulting system condition, such as a measured system pressure, may then be compared to an expected system condition, either quantitatively or qualitatively, to arrive at one or more conclusions about the status of the fuel cell system. For example, the status and/or position of one or more system valves may be deduced. In some embodiments, an expected or resulting system condition may be an expected or resulting feed line condition. Such tests may operate under the assumption that the system 200 has been previously evaluated for tightness and that no leaks were identified. For example, a leakage test as described further below may be utilized for verification. These tests may further operate under the assumption that there are no active consumers of reactants, such as fuel, online while the tests are being performed. In some embodiments, a baseline pressure reading may first be taken at the beginning of a test sequence, such as using the pressure sensor 255, for a future point of comparison.

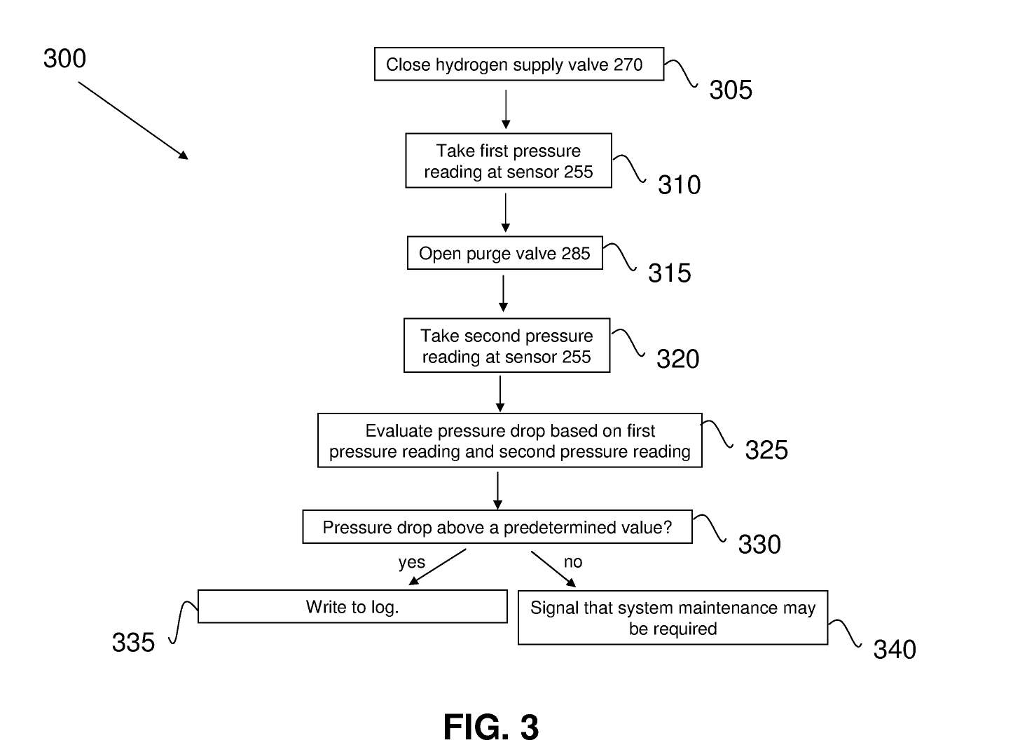

In one test 300, illustrated by the flow chart of FIG. 3, the position of the building inlet valve 285 and the safety shutoff valve 290 may be verified. This test may also verify performance of the hydrogen supply valve 270. In a first stage 305 of the test 300, the controller closes hydrogen supply valve 270, and a first pressure reading (stage 310) is recorded using the pressure sensor 255. The purge valve 280 is then opened (stage 315) and a second pressure reading is taken at stage 320 using the pressure sensor 255. A pressure drop between the first and second readings is evaluated at stage 325. A significant pressure drop between the first and second pressure readings may indicate that the valves 285, 290 were properly in open position and that the hydrogen supply valve 270 did close when instructed. For example, a pass criterion, such as a 3 bar pressure drop, may be predetermined for the test. At stage 330, the pressure drop is compared to a threshold. If the pressure drop is greater than the threshold, indicating a satisfactory outcome, then this result may be noted (stage 335) electronically or stored in a database. If the output of stage 330 is no, then the system may signal to an operator (stage 340) that system maintenance is required. System maintenance may include, for example, opening of one or more manual valves and/or repairing one or more automatic valves.

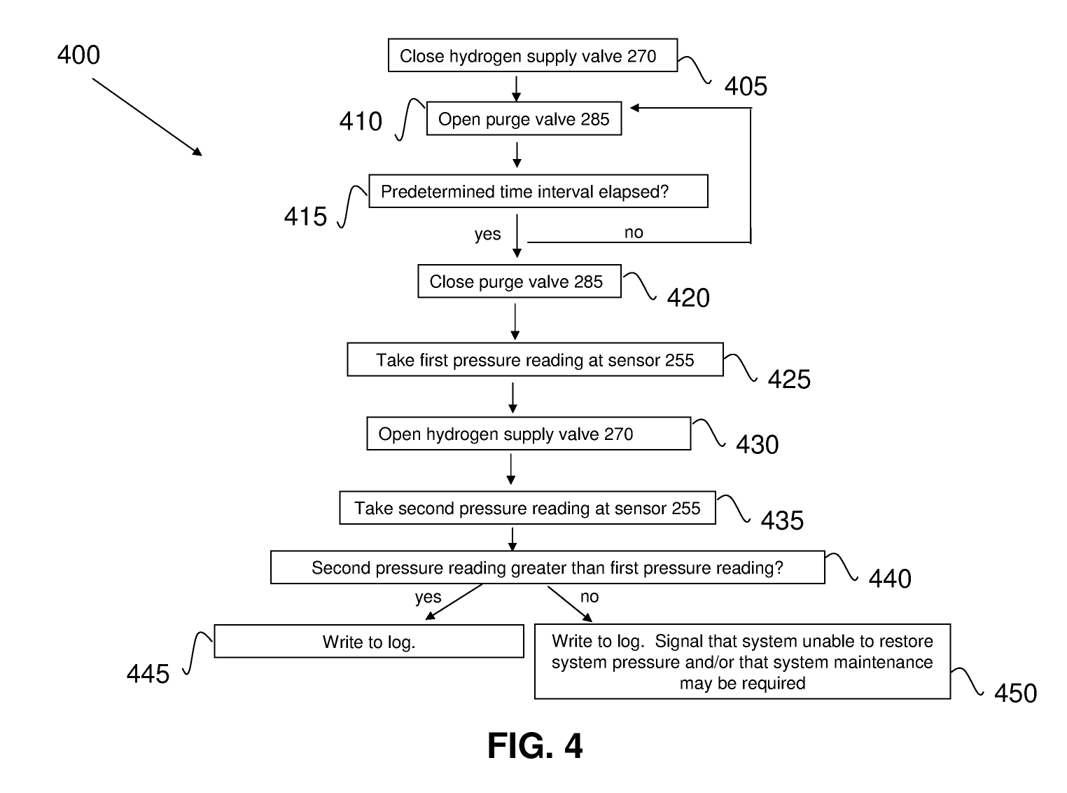

In another test 400, illustrated by the flow chart of FIG. 4, the position of one or more manual valves associated with the fuel source 240, such as the bottle valve 245, may be verified. In a first stage 405 of test 400, the hydrogen supply valve 270 is closed and in stage 410 the purge valve 285 is opened for a predetermined time interval (stage 415), such as 10 seconds, to purge the fuel supply line 205. The purge valve 285 is then closed (stage 420), and a first pressure reading is recorded at stage 425 using the pressure sensor 255. The hydrogen supply valve 270 is then opened at stage 430 to restore system pressure. A second pressure reading is taken at stage 435 using the pressure sensor 255. At stage 440, the second pressure reading is compared with the first pressure reading. If the second pressure reading is greater than that of the first pressure reading, then it may be confirmed that the bottle valve 245 was properly in open position and at stage 445 a log or database may be updated to include the results of the test. If the system was unable to restore system pressure, then the position of the bottle valve 245 may require attention and an operator may be notified at stage 450. This purging and pressurization routine may be repeated one or more times. In some embodiments, the purging and pressurization routine may be repeated two, three or four times.

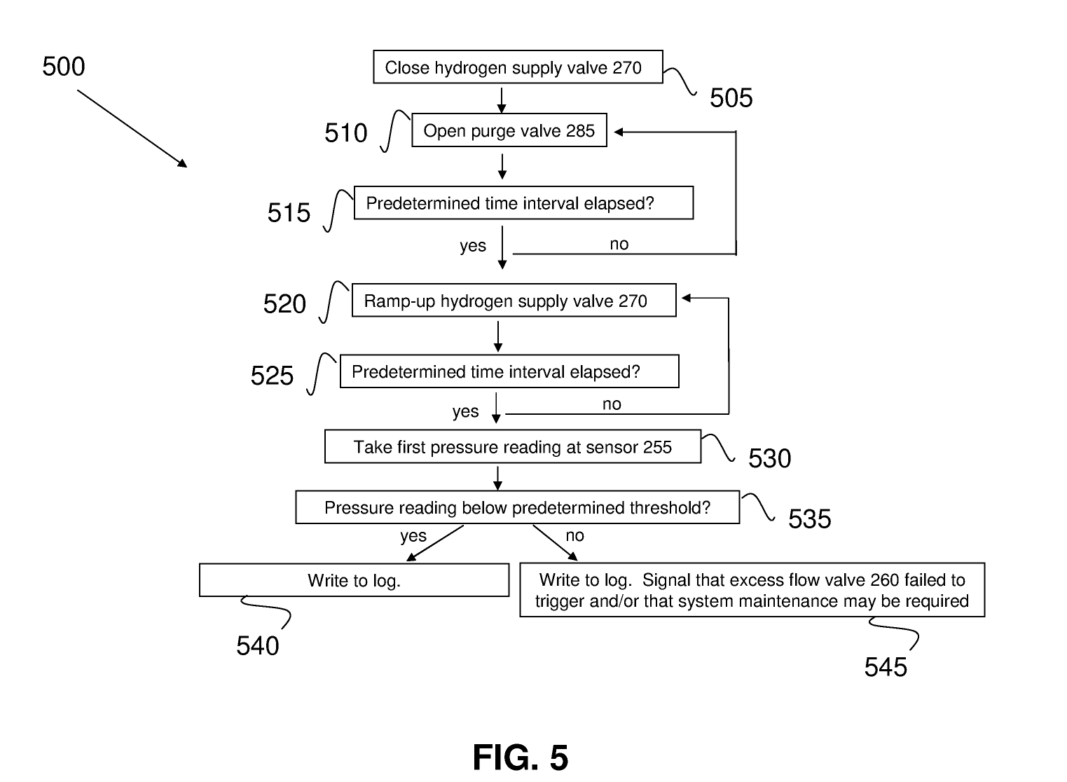

In accordance with one or more embodiments, a disclosed test may simulate a foreseeable event to evaluate system response. For example, a test 500 may be performed to verify functionality of the excess flow valve 260 by simulating a pipe burst as illustrated by the flow chart of FIG. 5. In this test sequence, the hydrogen supply valve 270 is closed at stage 505 and the purge valve 285 is opened at stage 510. After a predetermined period of time (stage 515), such as 10 seconds, the hydrogen supply valve 270 is opened at stage 520 while the purge valve 285 remains opened. In some embodiments, the valve 270 may be opened in a stepped fashion, or other manner capable of accelerating fuel flow therethrough so as to generally simulate a pipe burst. After a predetermined period of time (stage 525), 5 seconds for example, a first pressure reading may be recorded using the pressure sensor 255 at stage 530. The first pressure reading is compared to a predetermined threshold at stage 535. For example, a pass criterion for this test may be established as a pressure reading of less than 1 barg. If the recorded pressure is near zero, then the excess flow valve 260 properly triggered and this result may be noted (stage 540). If the pressure reading is not near zero, this may indicate that the excess flow valve 260 did not trigger and an error message may be generated to a system operator at stage 545. Another potential explanation is that the hydrogen supply valve 270 did not close but this may be unlikely if previously tested as discussed above.

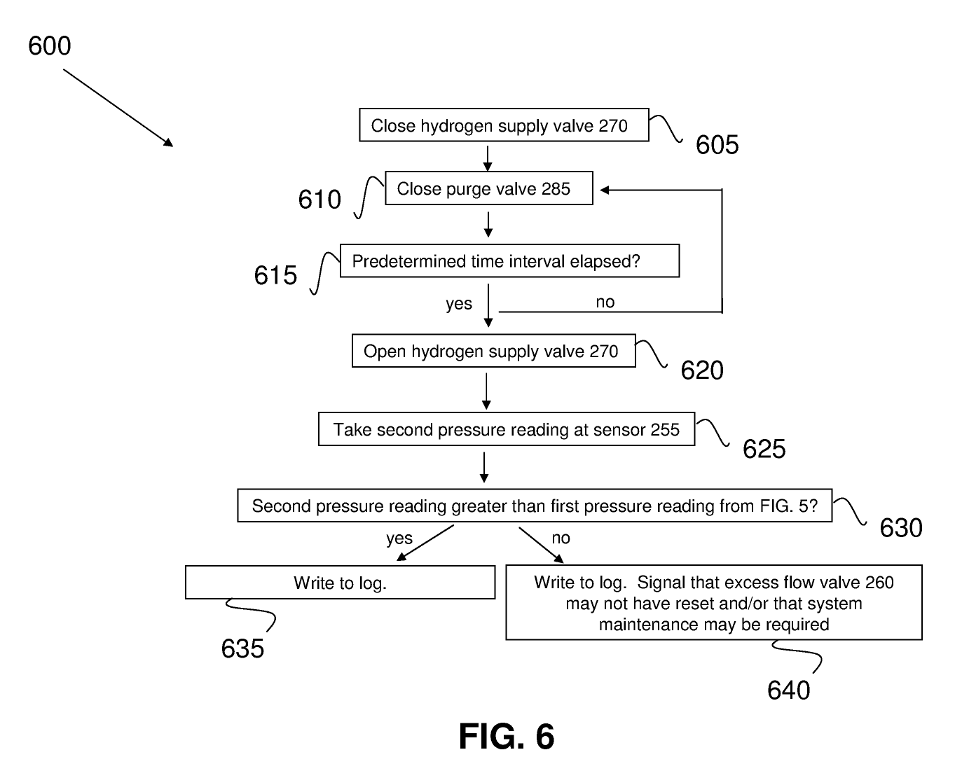

Resetting of the excess flow valve 260 may then be confirmed with an exercise 600 as illustrated by the flow chart of FIG. 6. The excess flow valve 260 may be allowed to reset, such as by closing both the hydrogen supply valve 270 (stage 605) and the purge valve 285 (stage 610) and waiting for a period of time (stage 615), for example, 2 minutes. The hydrogen supply line 205 is then be repressurized by opening the hydrogen supply valve 270 at stage 620 to verify that the excess flow valve 260 is no longer tripped. The hydrogen supply valve 270 may generally be opened slowly to avoid retriggering the excess flow valve 260. A second pressure reading is taken at stage 625 using pressure sensor 255. The second pressure reading is compared to the first pressure reading taken after the excess flow valve 260 triggered at stage 630. If the second pressure reading is greater than the first pressure reading, then the excess flow valve properly reset and a log or database may be updated to include the results of the test (stage 635). If the second pressure reading indicates that the hydrogen supply line 205 did not repressurize, then the excess flow valve 260 may still be tripped and an operator is notified that the system requires attention (stage 640). Other scheduled tests may need to be postponed until this test 600 indicates that the excess flow valve 260 has been reset.

In accordance with one or more embodiments of the present invention, a disclosed fuel cell functionality test may be a leakage test. Pipe leaks in reactant supply lines may adversely affect fuel cell performance and may be dangerous depending on severity. Small leaks, such as those due to pipe imperfections should be detected as early as possible to prevent worsening. Sudden leakages due to critical pipe failures or very loose fittings should be addressed as soon as possible, particularly in light of safety concerns. A leakage test may be effective in verifying the tightness and seal of a reactant supply line, such as the hydrogen supply line 205. A leakage test may also be effective in identifying whether any potential leakage event occurred in the proximity of a fuel cell, such as inside a fuel cell module 215, or rather at a remote point along the hydrogen supply line 205. The disclosed leakage tests may operate under the assumption that the position of various valves has been validated, such as through execution of a test described above. Leakage control may be continuously performed while the fuel cells are on standby, and may be halted during any time interval wherein the fuel cells are brought online. Any manner of detecting leaks commonly known to those skilled in the art may be implemented in the disclosed leakage tests.

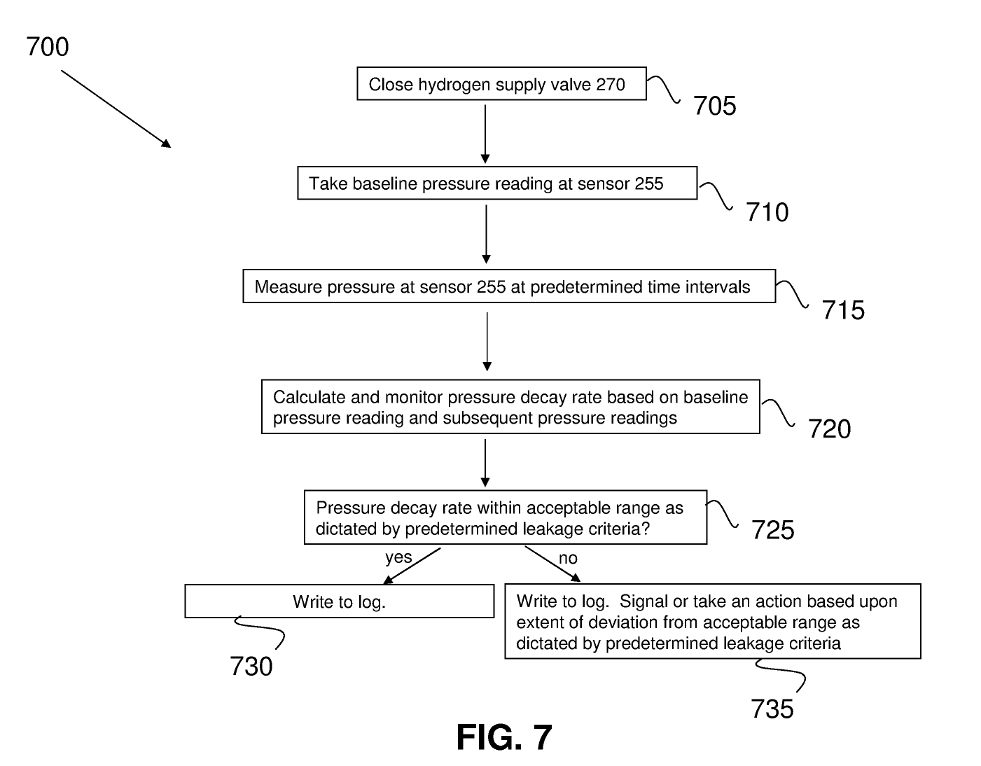

In at least one embodiment, a leakage test 700 may generally involve pressure decay testing as illustrated by the flowchart of FIG. 7. For example, when the fuel cell system 200 is in standby mode, the hydrogen supply valve 270 is closed at stage 705 and a baseline pressure reading recorded at sensor 255 (stage 710). The pressure within hydrogen supply line 205 is then measured at predetermined time intervals at stage 715. A pressure decay rate is calculated and monitored based on the baseline pressure reading and subsequent pressure readings at stage 720 according to the formula:

$$\frac{d \%}{d t} = \frac{( \frac{{P}_{init} - {P}_{end}}{{P}_{init}} ) * 100 \%}{( {t}_{init} - {t}_{end} )}$$

The pressure decay rate is compared to a predetermined acceptable range at stage 725. If a detected pressure decay rate is determined to be acceptable, this result is recorded at stage 730. If a detected pressure decay rate is determined to be unacceptable, a system operator may be notified or the system may take action at stage 735. The system response may be dictated, for example, by the extent of deviation from the predetermined acceptable range.

Thus, pressure decay rate may be monitored based on a detected initial supply line pressure. In some embodiments, temperature compensation may be incorporated into the disclosed leak test algorithms. In those embodiments, the disclosed systems will generally further include one or more temperature sensors. In other embodiments, average temperatures from various locations may be used to obtain information about pressure decay rate error due to temperature fluctuations, and that information may be taken into account in evaluating collected data. Without wishing to be bound by any particular theory, pressure changes may be directly proportional to temperature changes, such as in accord with the ideal gas law.

A number of leakage criteria may be predetermined by a user to correspond with various potential rates of pressure decay. For example, the condition of the hydrogen feed line can be monitored and evaluated to be tight if within a first range of pressure decay rates. As used herein, the term “tight” refers generally to being within an acceptance criterion chosen from a reference standard. The piping system may generally not be expected to be completely tight so a small leakage may be acceptable. A second range of pressure decay rates may be associated with very small leakage or increased temperature of gas. A third range of pressure decay rates may indicate minor leakage that over time will become a safety hazard. A fourth range of pressure decay rates may indicate large leakage that soon will become a safety hazard. A fifth range of pressure decay rates may indicate a very large leakage that will immediately be a safety hazard.

As discussed above, a user may generally dictate the level of sensitivity that the system should have in terms of responding to collected data. For example, the user may specify that certain detected pressure decay rates, such as pressure decay rates predetermined to be acceptable, should be ignored by the controller. The user may also specify that certain detected pressure decay rates should be reported to the user, such as via an automatic call or other message, who may then decide what further action to take, if any. The user may also specify that the controller should halt the system and query the user as to how to proceed in response to detecting a threshold pressure decay rate. Likewise, the user may specify that the controller contact a technician directly in response to detecting a threshold pressure decay rate. The user may also dictate that the system should refuse to operate, such as by refusing to open hydrogen supply valves, in response to detecting a threshold pressure decay rate until the system is serviced.

In at least one embodiment, the controller may correlate a detected pressure decay rate with a predetermined leak score, for example, as presented in the rubric of Table 1 below. Depending upon the volume of hydrogen kept inside the fuel pipes, a pressure drop measured in %/h corresponds to a given absolute leak rate. Since the volume of the fuel pipes may only vary with length, a calculated leak rate may be expressed in terms of pipe length, such as between 20 and 100 meters of piping.

In some embodiments, a theoretic acceptance criterion may be set based on an established reference standard. In other embodiments, industry knowledge may generally inform the choice of acceptance criterion. For example, in at least one embodiment, the good practice techniques for installing piped gas systems in Denmark as disclosed in the paper Centralanloeg for gasser: Distribution plant for gases at user's works, DS/INF 111, Dansk Standard: 1996-02-16, may be used to establish a leak rate acceptance criterion of 0.4%/h. Compensating for temperature error may yield an acceptance leak rate with temperature compensation. For example, based on the testing rubric of Table 1, if a measured leak rate is below 0.37%/h, the controller may register a leak score of 1 and the fuel cell system may be considered tight.

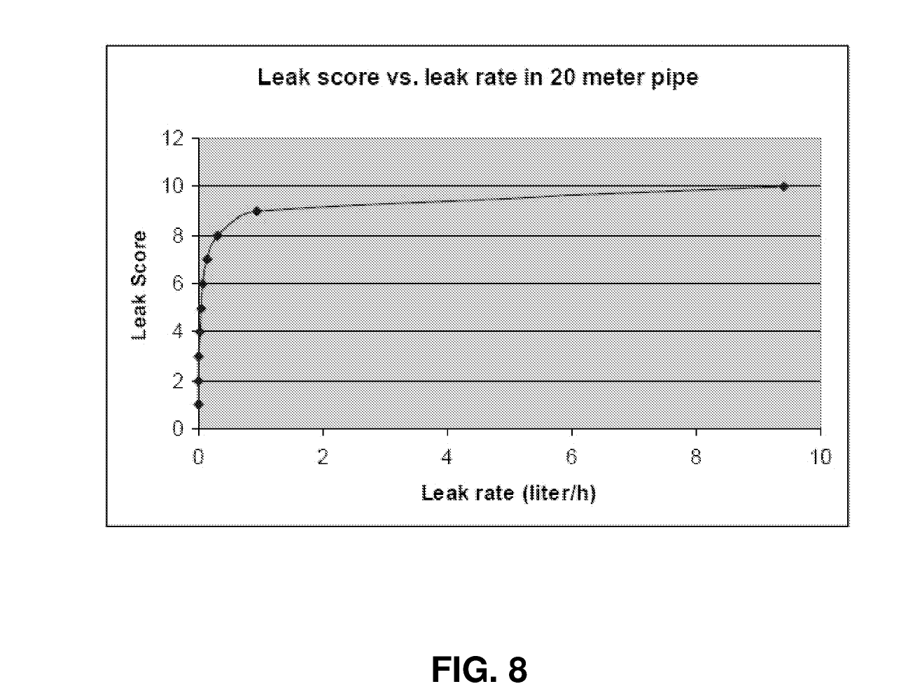

In some embodiments, an upper limit leak score may be established, for example, based on various foreseeable events that may be predetermined to require complete shutdown and refusal to startup until after system maintenance. For example, equipment such as a site fork lift may cause serious damage to feed line piping resulting in a dangerous and/or unacceptably high pressure decay rate. Likewise, a technician may only hand tighten a connector leaving a loose pipe connection resulting in a dangerous and/or unacceptably high pressure decay rate. In some embodiments, the highest leak score (such as a leak score 10) may be chosen to correlate with a leak rate of 1000%/h. In effect this means that a leaking hydrogen pipe would be evacuated of pressure in less than 10 minutes. Likewise, the second highest leak score (leak score 9) may be chosen to correlate with a leak rate of 100%/h. In effect this means that a leaking hydrogen pipe would be evacuated of pressure in less than 1 hour. A range of intermediate leak scores may also be predetermined. FIG. 8 presents a graphical representation of the leak scores versus leak rates of the Table 1 rubric.

TABLE 1
Example of a Leak Score Rubric.

| | | | Acceptance | | | | | |
|---|---|---|---|---|---|---|---|---|
| | | Max. temperature | leak rate with | Resulting absolute leak | | | | |
| | Theoretic | error taken into | temperature | rate (L/h) vs. pipe length (m) | | | | |
| Leak | leak rate | account | compensation | (Assuming initial pipe pressure of 6 bar) | | | | |
| score | %/h | ° C. | %/h | 20 | 40 | 60 | 80 | 100 |
| 1 | 0.4 | 7 | 0.37 | 0.0035 | 0.007 | 0.0105 | 0.014 | 0.0175 |
| 2 | 0.5 | 7 | 0.47 | 0.0044 | 0.0088 | 0.0131 | 0.0175 | 0.0219 |
| 3 | 1 | 0 | 1 | 0.009 | 0.019 | 0.028 | 0.038 | 0.047 |
| 4 | 2 | 0 | 2 | 0.019 | 0.038 | 0.057 | 0.075 | 0.095 |
| 5 | 4 | 0 | 4 | 0.04 | 0.08 | 0.11 | 0.15 | 0.19 |
| 6 | 6 | 0 | 8 | 0.08 | 0.15 | 0.23 | 0.3 | 0.38 |
| 7 | 16 | 0 | 16 | 0.15 | 0.3 | 0.45 | 0.6 | 0.75 |
| 8 | 32 | 0 | 32 | 0.3 | 0.6 | 0.9 | 1.21 | 1.51 |
| 9 | 100 | 0 | 100 | 0.9 | 1.9 | 2.8 | 3.8 | 4.7 |
| 10 | 1000 | 0 | 1000 | 9.4 | 18.8 | 28.3 | 37.7 | 47.1 |

A user may predetermine what leak scores may be considered acceptable or unacceptable. A controller may determine and monitor the leak score of a fuel cell system. Furthermore, a user may predetermine what action, if any, a controller should take upon detecting a particular leak score. In some embodiments, a controller may be programmed with various stop criteria based on a leak score rubric, such as that of Table 1. For example, a controller algorithm may stop to report that the fuel cell system is tight if a predetermined time interval, such as an hour, expires without exceeding a leak score of 1. The controller may then resume the leak score monitoring algorithm. In at least one embodiment, leak scores and leak score actions may be established, for example, by the manufacturer. User access to change certain system settings may be restricted.

The controller may further be programmed to evaluate the system for a particular leak score, such as at a predetermined time interval. For example, every 0.5 minute, the controller may evaluate the fuel cell system for a leak score of 7, 8, 9 and/or 10. If any of these leak scores is detected, the controller may take an action. For example, the controller may refuse to operate the fuel cell system in an online mode of operation until the system undergoes maintenance. Likewise, the system may evaluate the system for a leak score of 3, 4, 5 and/or 6 at predetermined intervals, such as every 15 minutes. Again, the controller may be programmed to take an action upon detecting any of these leak scores. For example, the controller may send an automatic message or warning to a system operator signaling that maintenance may be required and/or seek user input.

Data collected during various tests or exercises may be recorded by the controller, such as written to a log or electronic database, regardless of whether the fuel cell system passed or failed a particular test based on predetermined criteria. If the disclosed tests are being performed in series, then the controller may proceed upon completion of a test to the next scheduled test. The testing schedule may be halted or terminated when the fuel cells are brought online to generate power, and only resumed/restarted upon return of the fuel cells to standby mode. Thus the controller may be configured to alternate between a first and second mode of operation. In the event that any given test uncovers a potential source of system malfunction, a user may be alerted by the controller and/or the controller may take a predetermined action. In some embodiments, subsequent scheduled tests of the controller's testing algorithm may be aborted pending system maintenance. In other embodiments, the controller may schedule new tests for a future time, such as in 24 hours, so as to ensure that the user is reminded that preventative and/or corrective action may need to be taken.

Other embodiments of the disclosed fuel cell systems and methods are envisioned beyond those exemplarily described herein.

As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims.

Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Those skilled in the art should appreciate that the parameters and configurations described herein are exemplary and that actual parameters and/or configurations will depend on the specific application in which the systems and techniques of the invention are used. Those skilled in the art should also recognize, or be able to ascertain, using no more than routine experimentation, equivalents to the specific embodiments of the invention. It is therefore to be understood that the embodiments described herein are presented by way of example only and that, within the scope of the appended claims and equivalents thereto, the invention may be practiced otherwise than as specifically described.

What is claimed is:

1. A back-up power supply system, comprising:
a fuel cell stack;
a feed line fluidly connecting the fuel cell stack to a fuel supply;
a pressure sensor disposed along the feed line, configured to detect a pressure within the feed line;
a first valve configured to regulate flow of fuel to the fuel cell stack; and
a controller, in communication with the pressure sensor and the first valve,
configured to generate a first control signal to actuate the first valve to supply fuel to the fuel cell stack during a first mode of operation to provide output power from the fuel cell stack, and to generate a second control signal to close the valve during a second mode of operation,
the controller further configured to induce a feed line condition during the second mode of operation to verify feed line functionality.

2. The system of claim 1, further comprising an excess flow valve disposed along the feed line, wherein the feed line condition comprises actuation of the excess flow valve.

3. The system of claim 2, further comprising a purge valve disposed downstream of the excess flow valve, wherein the controller is configured in the second mode of operation to
generate a first control signal to open the purge valve,
generate a second control signal to accelerate a flow of fuel at the first valve,
detect a first pressure along the feed line with the pressure sensor, and
compare the first detected pressure to a threshold value.

4. The system of claim 3, wherein the controller is further configured to generate a warning in response to the first detected pressure exceeding the threshold value.

5. The system of claim 3, wherein the controller is configured to generate the second control signal a first predetermined time interval after generation of the first control signal.

6. The system of claim 3, wherein the controller is configured to detect the first pressure along the feed line after a second predetermined time interval.

7. The system of claim 3, wherein the controller is further configured to induce a reset of the excess flow valve during the second mode of operation.

8. The system of claim 7, wherein the controller is configured to
generate a third control signal to close the first valve,
generate a fourth control signal to close the purge valve,
generate a fifth control signal to open the first valve,
detect a second pressure along the feed line with the pressure sensor, and
compare the second detected pressure to the first detected pressure.

9. The system of claim 7, wherein the controller is further configured to generate a warning if the second detected pressure is less than the first detected pressure.

10. The system of claim 8, wherein the controller is configured to generate the fifth control signal after a third predetermined time interval.

11. The system of claim 1, wherein the feed line condition comprises a pressure drop above a threshold value.

12. The system of claim 11, further comprising a purge valve disposed along the feed line, and wherein the controller is configured in the second mode of operation to
generate a first control signal to close the first valve,
detect a first pressure along the feed line with the pressure sensor,
generate a second control signal to open the purge valve,
detect a second pressure along the feed line with the pressure sensor, and
evaluate a pressure drop based on the first and second detected pressures.

13. The system of claim 12, wherein the controller is further configured to generate a warning if the pressure drop is less than the threshold value.

14. The system of claim 1, wherein the feed line condition comprises a feed line pressure increase.

15. The system of claim 14, further comprising a purge valve disposed along the feed line, and wherein the controller is configured in the second mode of operation to
generate a first control signal to close the first valve,
generate a second control signal to open the purge valve,
generate a third control signal to close the purge valve after a predetermined time interval,
detect a first pressure along the feed line with the pressure sensor,
generate a first control signal to open the first valve,
detect a second pressure along the feed line with the pressure sensor, and
compare the first detected pressure to the second detected pressure.

16. The system of claim 15, wherein the controller is further configured to generate a warning if the second detected pressure is less than the first detected pressure.

17. A method of operating an uninterruptible power supply, comprising:
providing power derived from a fuel cell stack to a load during a first mode of operation;
powering-down the fuel cell stack during a second mode of operation; and
inducing a feed line condition during the second mode of operation to verify feed line functionality.

18. The method of claim 17, wherein inducing a feed line condition during the second mode of operation to verify feed line functionality comprises inducing actuation of an excess flow valve.

19. The method of claim 18, wherein inducing actuation of an excess flow valve comprises opening a purge valve, and accelerating a flow of fuel at a first valve disposed along the feed line.

20. The method of claim 19, further comprising detecting a first pressure along the feed line, and comparing the first detected pressure to a threshold value.

21. The method of claim 20, further comprising generating a warning in response to the first detected pressure exceeding the threshold value.

22. The method of claim 18, further comprising inducing a reset of the excess flow valve.

23. The method of claim 17, wherein inducing a feed line condition during the second mode of operation to verify feed line functionality comprises inducing a feed line pressure drop above a threshold value.

24. The method of claim 23, wherein inducing a pressure drop above a threshold value comprises:
closing a first valve disposed along the feed line;
detecting a first pressure along the feed line;
opening a purge valve;
detecting a second pressure along the feed line; and
evaluating a pressure drop based on the first and second detected pressures.

25. The method of claim 24, further comprising generating a warning if the pressure drop is less than the threshold value.

26. The method of claim 17, wherein inducing a feed line condition during the second mode of operation to verify feed line functionality comprises inducing a feed line pressure increase.

27. The method of claim 26, wherein inducing a feed line pressure increase comprises:
closing a first valve disposed along the feed line;
opening a purge valve;
closing the purge valve after a predetermined time interval;
detecting a first pressure along the feed line;
opening the first valve;
detecting a second pressure along the feed line; and
comparing the first detected pressure to the second detected pressure.

28. The method of claim 27, further comprising generating a warning if the second detected pressure is less than the first detected pressure.

29. An uninterruptible power supply, comprising:
a power input configured to receive input power during a first mode of operation;
a power output configured to provide output power to a load; and
a controller operatively coupled to the power input and the power output, configured to:
provide output power at the power output derived from input power received at the power input during the first mode of operation,
provide output power at the power output derived from a fuel cell stack during a second mode of operation, and
induce a fuel cell stack feed line condition during the first mode of operation to verify feed line functionality.

30. The power supply of claim 29, wherein the controller is configured to induce actuation of an excess flow valve associated with the fuel cell stack feed line.

31. The power supply of claim 30, wherein the controller is configured to induce a reset of the excess flow valve.

32. The power supply of claim 31, wherein the controller is configured to induce a pressure drop in the fuel cell stack feed line above a threshold value.

33. The power supply of claim 29, wherein the controller is configured to induce a pressure increase in the fuel cell stack feed line.
